(19) United States
(12) Patent Application Publication
(10) Pub. No.: US 2019/0111944 A1
(43) Pub. Date: Apr. 18, 2019

(54) METHOD FOR CONVEYING INFORMATION DURING AN AUTONOMOUS DRIVE AND VEHICULAR INFORMATION PRESENTING DEVICE

(71) Applicant: YAZAKI CORPORATION, Tokyo (JP)

(72) Inventors: Kenichi Nagahashi, Shizuoka (JP); Yukio Suzuki, Shizuoka (JP)

(21) Appl. No.: 16/157,365

(22) Filed: Oct. 11, 2018

(30) Foreign Application Priority Data
Oct. 12, 2017 (JP) 2017-198809
Mar. 12, 2018 (JP) 2018-044600

(51) Int. Cl. B60W 50/14

(52) U.S. Cl. CPC B60W 50/14; G05D 1/0088

(57) ABSTRACT

Until a lapse of a prescribed time from switching to a manual drive mode, a special judgment criterion for judging whether to generate an attention-arousing event is employed so that an attention-arousing event is generated more frequently than in an ordinary state and information is presented to a driver in a different expression form than in the ordinary situation. Since after occurrence of a handover the frequency of arousing attention of the driver is increased and attention of the driver is aroused in a different form, the driver realizes the switching to the manual drive mode soon and hence mode confusion can be avoided. Arousing attention of the driver is started earlier than in the ordinary situation by changing the judgment criterion for judging whether to generate an attention-arousing event.

### CROSS REFERENCE TO RELATED APPLICATIONS

This application is based on and claims priority from Japanese patent applications No. 2017-198809 filed on Oct. 12, 2017, and No. 2018-044600 filed on Mar. 12, 2018, the entire contents of which are incorporated herein by reference.

### BACKGROUND OF THE INVENTION

### 1. Technical Field

The present invention relates to a method for conveying information during an autonomous drive and a vehicular information presenting device that can be employed in vehicles capable of autonomous driving.

### 2. Background Art

Automobile manufacturers are now developing technologies for automatizing part of drive manipulations and autonomous drive technologies for allowing a system including a computer to perform almost all drive manipulations automatically in place of a driver (refer to Patent documents JP-A-2016-182906 and JP-A-2017-26417).

Patent document JP-A-2016-182906, which relates to a drive assist system, discloses a technique for allowing the driver to recognize a surrounding traffic situation quickly when an autonomous drive is canceled. More specifically, when receiving a notice or an advance notice of switching from an autonomous drive to a manual drive, the system displays, on the display provided in a meter cluster panel, a vehicle speed of the self vehicle, a rear-view video, an image indicating a front road shape, an image indicating locations of vehicles around the self vehicle, and an image indicating a distance to the vehicle immediately ahead and a situation around it.

Patent document JP-A-2017-26417, which relates to an information presenting system, discloses a technique for presenting information recognized by an autonomous driving system to the driver in response to his or her instruction. More specifically, the information presenting system switches the display mode of a display unit in response to a display switching instruction from the driver. The information presenting system has a display mode in which to display set information of an autonomous drive, a display mode in which to display running information during operation of the autonomous driving system, and a display mode in which to display recognition result information of the autonomous driving system.

### SUMMARY

Incidentally, while a vehicle in which an autonomous driving system is installed is doing an autonomous drive, it may encounter a special situation that the system cannot deal with properly, that is, the accuracy of recognizing or judging the situation lowers. In such a situation, it is expected that the drive of the vehicle is continued according to judgments and drive manipulations of the driver by switching, for example, from an autonomous drive mode to a manual drive mode (a handover from the system to the driver) or, if it is impossible, the vehicle is stopped automatically. Alternatively, switching may be made from an autonomous drive mode in which no assistance from the driver is necessary at all to an autonomous drive mode in which assistance from the driver is necessary.

To enable a smooth handover from the autonomous drive mode to the manual drive mode, it is necessary for the system to arouse attention of the driver by a certain means before occurrence of an actual handover to urge him or her to prepare for the handover.

However, each of various handover-causing situations predicted by the system may either occur or does not occur actually. That is, after the system predicts a possible situation that the autonomous drive mode cannot be continued, in actuality a handover may become necessary or the autonomous drive may continue because of issuance of no handover request from the system.

One specific example handover-causing drive situation is a situation that the self vehicle has reached an area for which no map data necessary for an autonomous drive is available. In this situation, a handover occurs because it is difficult to continue an autonomous drive.

On the other hand, for example, in the vicinity of an interchange of an expressway, a difficult-to-drive situation tends to occur such as a situation that the number of vehicles going to change a running course due to merging of plural lanes of a road or branching into plural lanes or a situation that a course ahead is blocked by other vehicles due to a traffic congestion. In such a situation, the system may issue a handover request because it is difficult to attend to the situation safely only by an autonomous drive. However, even in the vicinity of an interchange, the probability that the system does not issue a handover request is high if, for example, the traffic is relatively light.

Where occurrence of a handover is fixed, if arousing of attention of the driver as an advance notice of the handover is made too early, the driver is forced to be ready for the handover unnecessarily for a long time from the arousing of attention of the driver to actual occurrence of the handover and hence the comfortability of the autonomous drive is impaired. That is, since the driver is kept cautious as in the case of a manual drive for a long time from output of attention-arousing information to actual occurrence of the handover though an autonomous drive is being performed, the driver would feel the attention arousing to be annoying.

However, if attention of the driver is not aroused in advance, a message such as “Being switched to a manual drive” is output suddenly immediately before (e.g., 10 seconds before) the vehicle reaches a point where driving is difficult. Since the driver is not ready at this time point, he or she would be confused and may not be able to attend to the handover smoothly.

For example, a level-3 autonomous drive (described later) includes a state that usually the driver need not watch a driving state or a surrounding situation unless a handover request is issued because of occurrence of a situation that the system cannot deal with. Thus, in an autonomous drive state, the driver can enjoy a moving image, do an information search using a browser, or do other things irrelevant to the driving by watching the screen of an IVI (in-vehicle infotainment system).

However, if a handover request is issued suddenly in a state that the driver is watching the IVI screen, the driver may be thrown into a panic because he or she cannot understand the current situation and is not mentally ready for a start of a manual drive or assistance to an autonomous drive. On the other hand, if an act of the driver such as watching of a moving image is suspended by being attention-aroused at an early stage and if the waiting time to occurrence of an actual handover is long, it is highly probable that the driver is not satisfied with the attention arousing and feels it to be annoying.

The present invention has been made in view of the above circumstances, and an object of the invention is therefore to provide a method for conveying information during an autonomous drive and a vehicular information presenting device that can smoothly switch from a first state in which a drive control is performed automatically to a second state that is higher in the degree of involvement of a driver in drive control than the first state when the switching is necessary, and that can suppress lowering of the comfortability of an autonomous drive.

To attain the above object, the invention provides methods for conveying information during an autonomous drive and vehicular information presenting devices having features that will be described below in the form of items (1) to (8):

(1) A method for conveying information during an autonomous drive which presents information to a driver in a vehicle having, as running states, two or more states that are different from each other in the degree of involvement of the driver in drive control, wherein:

the running states include a first state in which the drive control is performed automatically and a second state that is higher in the degree of involvement of the driver in drive control than the first state; and if an encounter with an event that may cause switching from the first state to the second state is predicted,
explicit information is conveyed to the driver at a point in the vicinity of a scheduled switching point where switching from the first state to the second state will occur because of an encounter with the event; and
the information is conveyed to the driver using an output device or devices that stimulate at least one of the five senses of the driver in such a manner that the stimulus quantity is varied stepwise or continuously from an initial quantity between a switching advance notice start point that is more distant from the scheduled switching point than the point in the vicinity of it is and the scheduled switching point.

In the method for conveying information during an autonomous drive of item (1), information is conveyed to the driver with such a control that the stimulus quantity is increased gradually between the switching advance notice start point and the scheduled switching point. Thus, in a state that there is a sufficient time margin to occurrence of, for example, a handover, a strong stimulus or a large stimulus variation that would cause the driver to feel annoying is not generated. Since the stimulus as recognized by the driver is made stronger or its variation is increased as a time of occurrence of a handover approaches, the driver can prepare for the handover or switch to a manual drive voluntarily before the system issues a handover request. As a result, a smooth handover can be realized without impairing the comfortability of the driver and safety of driving can be secured.

(2) The method for conveying information during an autonomous drive according to item (1), wherein a display on a screen that is irrelevant to driving is caused to make a transition to a state that is hard to recognize visually, gradually and stepwise or continuously between the switching advance notice start point and the scheduled switching point.

According to the method for conveying information during an autonomous drive of item (2), when the driver is concentrating on an act such as watching of a moving image or an information search using a display on a screen that is irrelevant to driving while the self vehicle is doing an autonomous drive, it is possible to return, surely, the attention of the driver to the drive environment of the self vehicle by weakening his or her concentration. Furthermore, since this display is caused to make a transition gradually to a state that is hard to recognize visually, the driver can, for example, watch the moving image for a while, whereby the driver is less prone to feel uncomfortable.

(3) The method for conveying information during an autonomous drive according to item (1), wherein the display size of visible information that relates to the event is increased gradually and stepwise or continuously between the switching advance notice start point and the scheduled switching point.

According to the method for conveying information during an autonomous drive of item (3), since the display size of visible information is increased gradually, the visible information allows the driver to recognize intuitively that vehicle is coming closer to a point where a handover, for example, will occur.

(4) The method for conveying information during an autonomous drive according to item (1), wherein the sound volume of a content that is irrelevant to driving is decreased gradually and stepwise or continuously between the switching advance notice start point and the scheduled switching point.

According to the method for conveying information during an autonomous drive of item (4), since the sound volume of a content such as music that the driver is listening to is decreased gradually, the degree of concentration of the driver on the content lowers gradually and his or her attention can be diverted to such a direction that he or she will stop listening to the content.

(5) The method for conveying information during an autonomous drive according to item (1), wherein a musical piece that would cause the driver to think of an end of an autonomous drive is output additionally and the sound volume of the musical piece is increased gradually and stepwise or continuously between the switching advance notice start point and the scheduled switching point.

According to the method for conveying information during an autonomous drive of item (5), since the sound volume of a musical piece (e.g., “Auld Lang Syne”) that will cause the driver to think of an end highly probably is increased gradually, the driver can recognize intuitively that he or she needs to stop, for example, listening to a content.

(6) A vehicular information presenting device for presenting information to a driver in a vehicle having, as running states, two or more states that are different from each other in the degree of involvement of the driver in drive control, wherein:
the running states include a first state in which the drive control is performed automatically and a second state that is higher in the degree of involvement of the driver in drive control than the first state;
the vehicular information presenting device comprises an information output control unit which outputs, in association with switching from the first state to the second state, information relating to the switching; and
if an encounter with a special event that may cause switching from the first state to the second state is predicted, the information output control unit
   conveys explicit information to the driver at a point in the vicinity of a scheduled switching point where switching from the first state to the second state will occur because of an encounter with the event; and
   conveys the information to the driver using an output device or devices that stimulate at least one of the five senses of the driver in such a manner that the stimulus quantity is varied stepwise or continuously from an initial quantity between a switching advance notice start point that is more distant from the scheduled switching point than the point in the vicinity of it is and the scheduled switching point.

In the vehicular information presenting device having the configuration of item (6), information is conveyed to the driver with such a control that the stimulus quantity is increased gradually between the switching advance notice start point and the scheduled switching point. Thus, in a state that there is a sufficient time margin to occurrence of, for example, a handover, a strong stimulus or a large stimulus variation that would cause the driver to feel annoying is not generated. Since the stimulus as recognized by the driver is made stronger or its variation is increased as a time of occurrence of a handover approaches, the driver can prepare for the handover or switch to a manual drive voluntarily before the system issues a handover request. As a result, a smooth handover can be realized without impairing the comfortability of the driver and safety of driving can be secured.

(7) The method for conveying information during an autonomous drive according to item (1), wherein:
the information is conveyed to the driver using the output device or devices by a stimulus control of varying the stimulus quantity stepwise between the switching advance notice start point and the scheduled switching point; and
in the stimulus control the variation amount of each change of the stimulus quantity is variable reflecting a stimulus quantity before the change.

According to the method for conveying information during an autonomous drive of item (7), since the stimulus quantity is varied stepwise, the driver can recognize more easily that the manner of information conveyance is varying. In addition, the variation amount of each change of the stimulus quantity is variable reflecting a stimulus quantity before the change, which enables adaptation to the human sensory properties. That is, a control can be made so as not cause a situation that the driver cannot realize a change because it is too small or feel uncomfortable because a change is too large.

(8) The method for conveying information during an autonomous drive according to item (7), wherein:
in the stimulus control an environmental stimulus quantity other than an output or outputs of the output device or devices is detected; and
the variation amount is determined automatically so as to reflect the detected environmental stimulus quantity.

According to the method for conveying information during an autonomous drive of item (8), since the variation amount is determined so as to reflect a detected environmental stimulus quantity, a proper stimulus that is suitable for an environmental change can be imposed on the driver. For example, even in a situation that the driver is influenced by a variation of the brightness of an external environment or external noise occurring inside the self vehicle or in its neighborhood, it is possible to always impose, on the driver, a stimulus having such a proper quantity that its change is recognized by the driver.

The method for conveying information during an autonomous drive and the vehicular information presenting device according to the invention can smoothly switch from the first state in which a drive control is performed automatically to the second state that is higher in the degree of involvement of the driver in drive control than the first state when the switching is necessary, and can suppress lowering of the comfortability of an autonomous drive.

For example, in a situation that there is a sufficient time margin to occurrence of, for example, a handover, a strong stimulus or a large stimulus change that would cause the driver to feel annoying is not generated. Since the stimulus or stimulus variation as recognized by the driver becomes stronger or larger as a time of occurrence of a handover approaches, the driver can prepare for the handover or switch to a manual drive voluntarily before the system issues a handover request. As a result, a smooth handover can be realized without impairing the comfortability of the driver and safety of driving can be secured.

The invention has been described above concisely. The details of the invention will become more apparent when the modes for carrying out the invention (hereinafter referred to as an embodiment) described below are read through with reference to the accompanying drawings.

### BRIEF DESCRIPTION OF THE DRAWINGS

FIG. 1 is a plan view showing an example positional relationship between each point of a road and a self vehicle.

FIG. 2 is a block diagram showing an example configuration of an essential part of a vehicular system as an implementation of the present invention.

FIG. 3 is a flowchart showing an example process of a characteristic information presentation control that is performed in an embodiment of the invention.

FIG. 4 is a schematic diagram showing an example of how a display on the screen of an IVI is varied when the characteristic information presentation control is performed.

FIG. 5 is a schematic diagram showing an example of how a display of a front scene is varied when the characteristic information presentation control is performed.

FIG. 6 is a block diagram showing an example configuration of a vehicular system according to a modification of the embodiment.

FIGS. 7A and 7B are time charts showing examples of a time-series variation of the stimulus quantity in a case that the stimulus quantity is varied stepwise.

FIG. 8 is a flowchart showing an example handover advance notice control according to the modification of the embodiment.

FIG. 9 is a graph showing a relationship between the stimulus quantity and the stimulus variation.

FIG. 10 is a time chart showing a realistic example of a time-series variation of the stimulus quantity.

### DETAILED DESCRIPTION OF EMBODIMENTS

A specific embodiment of the present invention will be hereinafter described with reference to the drawings.

### <Outline of Method for Conveying Information During Autonomous Drive>

### <Outline of Autonomous Drive Control as Background>

To enable autonomous drive in an automobile, it is usually conceivable to install, in the vehicle, functions for performing autonomous driving of level-2 (LV2) or level-3 (LV3) among the automation levels prescribed by, for example, the Japanese government or the National Highway Traffic Safety Administration (NHTSA) of the U.S. Department of Transportation.

At level-2, the system automatically performs manipulations of plural ones of acceleration, steering, and braking of a vehicle. However, at level-2, the driver needs to watch the drive situation all the time and perform a drive manipulation when necessary.

On the other hand, at level-3, since the system controls all of acceleration, steering, and braking of the vehicle, usually the driver is required to merely watch the drive situation or even need not watch the drive situation. However, even at level-3, the driver needs to respond to a request from the system in the event of emergency or reduction in the accuracy of the system. That is, it is necessary to hand over (H/O) the responsibility of driving from the system to the manual manipulation by the driver and to make a transition from level-3 to level-2 or the like which is lower in the degree of automation than level-3. Even where the automation level is kept the same, a transition may be made from a running state in which assistance from the driver such as placing his or her hands on the steering wheel, assuming a duty to watch, starting of a lane change beginning with a blinker manipulation, and approval of a judgment of the system is not necessary during an autonomous drive of the self vehicle to a running state in which one or some of those kinds of assistance are necessary. That is, a transition may be made from a first state in which a drive control is performed automatically to a second state that is lower in the degree of involvement of the driver in drive control than the first state.

### <Example Positional Relationship Between Each Point of Road and Self Vehicle>

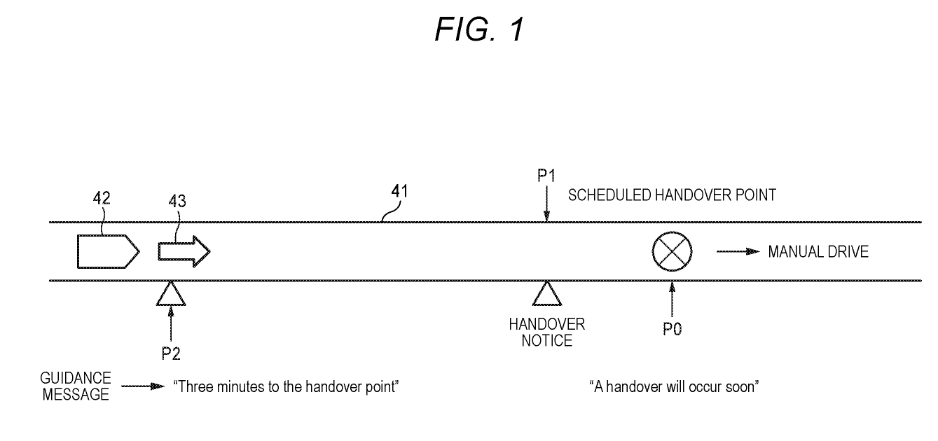

FIG. 1 is a top view showing an example positional relationship between each point of a road and a self vehicle. The example shown in FIG. 1 assumes a case that a scheduled handover point P0 exists ahead in a traveling direction 43 of a self vehicle 42 which is running in the level-3 autonomous drive mode.

For example, in a situation that a road map for an autonomous drive does not have data of a road ahead of the scheduled handover point P0, a level-3 autonomous drive cannot be done after the self vehicle 42 passes the point P0. In this case, a handover request for handing over the drive responsibility from the system to the driver and causing a transfer to the level-2 drive mode or the manual drive mode necessarily occurs.

Furthermore, at points such as an interchange of an expressway where the frequency of occurrence of course changes, congestions, etc. tends to be high due to merging of plural roads or branching into plural roads, a special situation tends to occur and hence is a latent scheduled handover point P0.

On the other hand, when the self vehicle 42 is running in the level-3 autonomous drive mode, usually the driver need not do such acts as watching a driving state hence can perform an act irrelevant to the driving or concentrate on listening to music or viewing of a moving image. Thus, if the system issues a handover request suddenly, for example, 10 seconds before the self vehicle 42 reaches a point concerned, when the driver is not ready for it at all, he or she would be confused and may not be able to attend to the handover smoothly.

### <Ordinary Information Conveying Method>

One countermeasure against the above problem is to output a guidance message at each of a scheduled switching notice issuance point P1 and a switching advance notice start point P2 that are short of the scheduled handover point P0 (see FIG. 1). More specifically, a guidance message “Three minutes to the handover point” is output at the switching advance notice start point P2 and a guidance message “A handover will occur soon” is output at the scheduled switching notice issuance point P1.

Recognizing these guidance messages, the driver can prepare for a handover before the self vehicle 42 reaches the scheduled handover point P0 and the handover occurs actually. The handover can therefore be made smoothly at the scheduled handover point P0.

On the other hand, where the scheduled handover point P0 is a latent special point that is high in danger, there may occur a case that the level-3 autonomous drive mode continues without occurrence of a handover at the point P0.

If no handover occurs actually at the scheduled handover point P0 though the system outputs a guidance massage at the switching advance notice start point P2, the preparation of the driver made from the switching advance notice start point P2 to the scheduled handover point P0 is wasteful. In particular, if the driver is notified clearly at the switching advance notice start point P2 of a scheduled handover and the distance between the switching advance notice start point P2 and the scheduled handover point P0 is long, the driver needs to be ready for a possible handover for an unnecessarily long time.

As a result, in the information conveying method shown in FIG. 1, the comfortability of the autonomous drive is lowered to a large extent and the driver would feel the guidance messages to be annoying that are output at the switching advance notice start point P2 and the scheduled switching notice issuance point P1. On the other hand, if the distance between the switching advance notice start point P2 and the scheduled handover point P0 is relatively short, the time margin with which the driver prepares for a handover may be too short to enable a smooth handover when it actually occurs at the scheduled handover point P0.

### <Outline of Information Conveying Method According to Embodiment>

In view of the above, in the embodiment of the invention a control is performed so that information about a possible handover is conveyed to the driver between, for example, the switching advance notice start point P2 and the scheduled switching notice issuance point P1 shown in FIG. 1 in such a manner that the manner of information conveyance is varied gradually as the self vehicle 42 goes toward the scheduled handover point P0. So that the driver does not get ready for the possible handover unnecessarily, a control is made so that an explicit message is not output if the situation allows it until the self vehicle 42 comes close to the scheduled switching notice issuance point P1. The stimulus, to the driver, of the expression form of information conveyance between the switching advance notice start point P2 and the scheduled switching notice issuance point P1 is set weaker than that at the scheduled switching notice issuance point P1.

### <Example Configuration of Vehicular System>

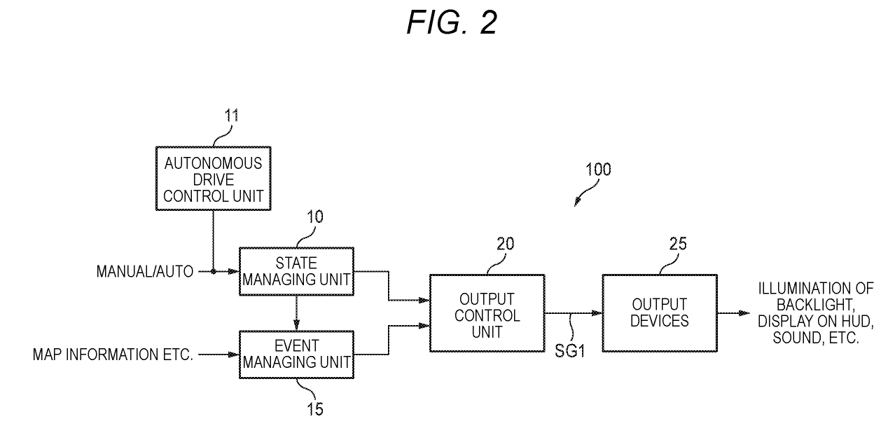

FIG. 2 shows an example configuration of an essential part of a vehicular system as an implementation of the invention. The vehicular system shown in FIG. 2 is equipped with an autonomous drive control unit 11 which performs an autonomous drive control on the self vehicle and a vehicular information presentation control device 100. The vehicular information presentation control device 100 is equipped with a state managing unit 10, an event managing unit 15, and an output control unit 20.

The autonomous drive control unit 11 is an electronic control unit (ECU) for performing an autonomous drive control on an automobile and is provided with functions for performing autonomous driving of level-2 (LV2) or level-3 (LV3) among the automation levels prescribed by, for example, the Japanese government or the National Highway Traffic Safety Administration (NHTSA) of the U.S. Department of Transportation.

That is, the autonomous drive control unit 11 can automatically perform an acceleration control, a deceleration control, a steering control, etc. on the self vehicle. The autonomous drive control unit 11 also has functions of detecting a position of the self vehicle using a GPS (global positioning system) or the like, detecting a distance using a radar, recognizing a running state on the basis of videos of vehicular cameras, and recognizing a scheduled running route on the basis of road map data, and other functions.

In the level-3 autonomous drive mode, when detecting a special situation that the system cannot deal with, the autonomous drive control unit 11 generates a request for handing over the responsibility of driving from the system to the driver. The driver performs a prescribed input manipulation in response to the handover request. If the driver approves the handover, a transition is made from the level-3 autonomous drive mode to the level-2 autonomous drive mode or the manual drive mode.

The autonomous drive control unit 11 can detect in advance, as a scheduled handover point P0 as shown in FIG. 1, an area where an autonomous drive cannot be performed because of absence of necessary road map data and a point with latent danger such as a point in the vicinity of an interchange of an expressway.

The state managing unit 10 shown in FIG. 2 recognizes and manages various states in the autonomous drive control unit 11. For example, the state managing unit 10 recognizes which of the autonomous drive mode and the manual drive mode the current drive mode is and, if the current drive mode is the autonomous drive mode, its level, whether assistance from the driver is necessary, and other things. The state managing unit 10 also recognizes whether a handover is scheduled and a scheduled handover point P0 as well as a situation relating to a handover request issued by the system to the driver.

The event managing unit 15 recognizes presence/absence of various events for which information is to be presented to the driver, kinds of events, and generation timing of each event on the basis of pieces of state information managed by the state managing unit 10, map information, etc. and manages them. For example, where a scheduled handover point P0 is recognized by the state managing unit 10, the event managing unit 15 generates a proper kind of event signal with predetermined timing (e.g., 30 seconds before, 1 minute before, or 2 minutes before) corresponding to each of a scheduled switching notice issuance point P1, a switching advance notice start point P2, etc. that are short of the scheduled handover point P0 and gives it to the output control unit 20.

The output control unit 20 controls a proper one (or ones) of output devices 25 by generating an information presentation control signal SG1 on the basis of the event signal that is output from the event managing unit 15. For example, one or a combination of a backlight for illuminating the display of an IVI (in-vehicle infotainment system), an HUD (head-up display), a sound volume adjusting unit, a sound output device, etc. can be used as the output devices 25.

The output control unit 20 employed in the embodiment, to which the method for conveying information during an autonomous drive is applied, performs a special control described later. For example, the output control unit 20 performs a control between a switching advance notice start point P2 and a scheduled switching notice issuance point P1 so that the expression form of information presentation is varied gradually as the self vehicle goes toward a scheduled handover point P0.

### <Example Process of Characteristic Information Presentation Control>

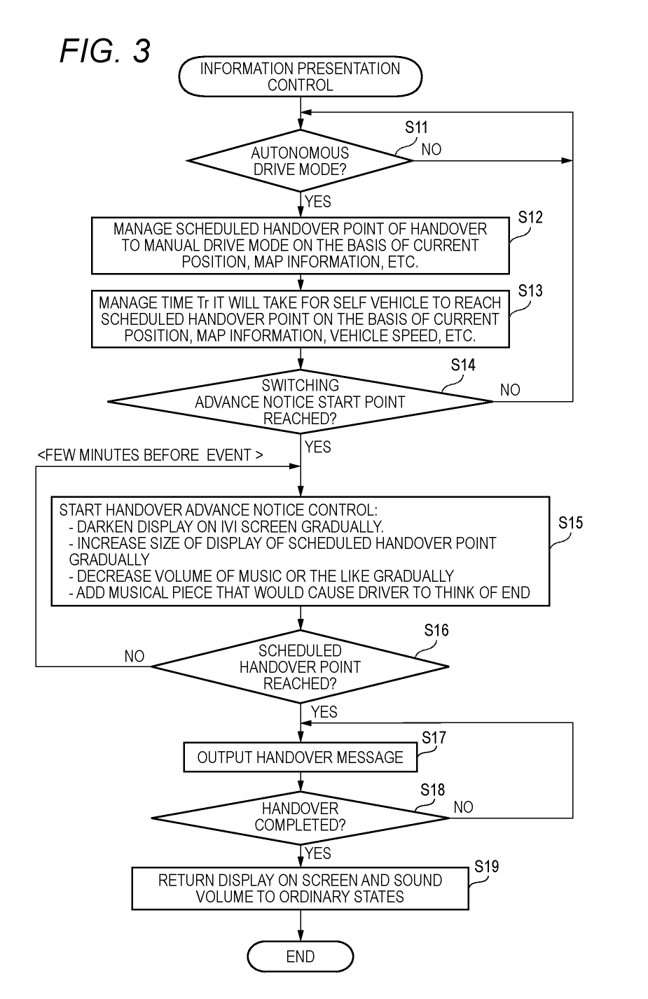

FIG. 3 shows an example process of a characteristic information presentation control that is performed in the embodiment of the invention. For example, one of the autonomous drive control unit 11, the state managing unit 10, the event managing unit 15, and the output control unit 20 shown in FIG. 2 performs the information presentation control shown in FIG. 3 and the output control unit 20 controls the output devices 25 according to an information presentation control signal SG1 generated by the output control unit 20, whereby necessary information can be conveyed to the driver. The example process shown in FIG. 3 will be described below.

While the self vehicle is running in the level-3 autonomous drive mode (step S11), at step S12 the autonomous drive control unit 11 or the state managing unit 10 recognizes a route along which the self vehicle is running on the basis of a current position of the self vehicle and map information and manages a scheduled handover point P0 by searching data of points within a prescribed range ahead on the route.

For example, the autonomous drive control unit 11 or the state managing unit 10 detects, as a scheduled handover point P0, a point where continuation of an autonomous drive is disabled because of absence of detailed map data that is necessary for an autonomous drive or a point where the probability of occurrence of a handover is high because of a road situation.

At step S13, the event managing unit 15 calculates a time Tr it will take for the self vehicle to reach the scheduled handover point P0 on the basis of the information relating to the scheduled handover point P0 recognized by the state managing unit 10, a current position, map information, a vehicle speed, etc. and manages it.

At step S14, the event managing unit 15 compares the latest required time Tr with a predetermined threshold value. If the required time Tr has decreased to a time corresponding to, for example, a switching advance notice start point P2 as shown in FIG. 1, the event managing unit 15 generates an event signal indicating an event meaning that it is several minutes before the scheduled handover. Receiving this event signal, at step S15 the output control unit 20 starts a handover advance notice control. The handover advance notice control is performed repeatedly until the self vehicle reaches the scheduled handover point P0 or the scheduled switching notice issuance point P1 (step S16).

As for the handover advance notice controls of step S15, the output control unit 20 performs, for example, one or a combination of controls of the following items (1) to (4) repeatedly as time elapses or the vehicle runs toward the scheduled handover point P0:

(1) the brightness of the illumination for a display on the IVI screen is decreased gradually.

(2) Where the scheduled handover point P0 is displayed on the screen of an HUD or the like, the size of a display indicating the point concerned is increased gradually or the content of the display is updated gradually so as to allow the driver to recognize that the self vehicle is coming closer to the point.

(3) The volume of a sound of music or the like the driver is listening to is decreased gradually.

(4) A particular musical piece that would cause the driver to think of an end, such as “Auld Lang Syne,” is reproduced and output additionally with its volume increased gradually.

If the self vehicle reaches the scheduled handover point P0 or the scheduled switching notice issuance point P1 which is a little short of it, the output control unit 20 moves from step S16 to step S17. At step S17, for example, a display or voice message “A handover will occur soon” is output on the basis of an information presentation control signal SG1 that is output from the output control unit 20.

If an input manipulation (e.g., a manipulation of gripping the steering wheel) of the driver indicating approval of a handover request that is output from the autonomous drive control unit 11 at the scheduled handover point P0 is detected, at step S18 the autonomous drive control unit 11 and the output control unit 20 judge that the handover has been completed. At step S19, the output control unit 20 controls an information presentation control signal SG1 to return the display on the screen and the sound volume of the output devices 25 to the ordinary states.

### <Specific Example of Information Presentation Form>

### <Example of Variation of Display on IVI Screen>

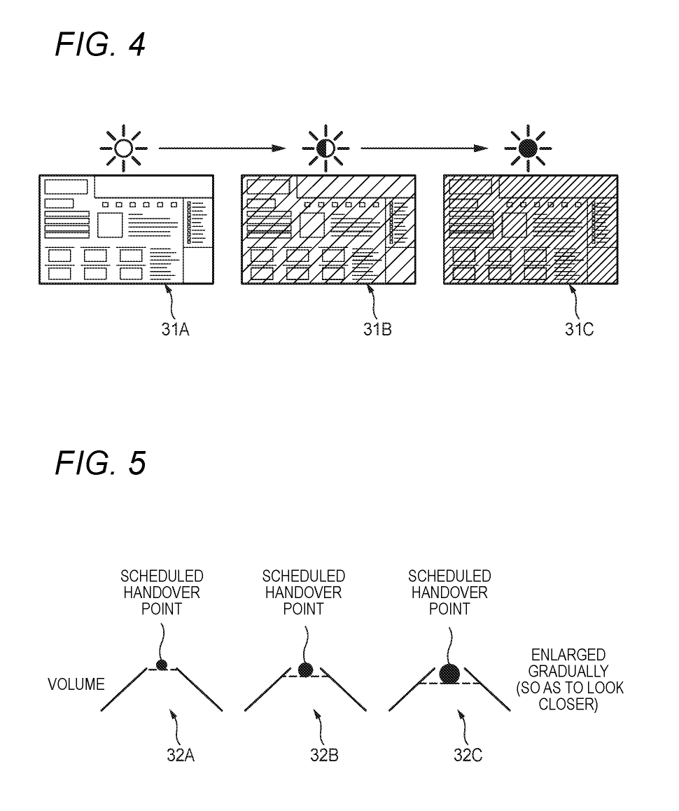

FIG. 4 shows an example of how a display on the IVI screen is varied when the characteristic information presentation control is performed.

While the self vehicle is running in the autonomous drive mode (level-3), the driver can do, for example, an act that is irrelevant to driving unless the system issues a request for assistance from the driver. Thus, the driver can watch a moving image, search for information on the Internet (see pictures shown in FIG. 4), or do some other thing on the display of an IVI device installed in the vehicle using application software such as a prescribed moving image player or browser.

However, where the driver is concentrating on, for example, watching of a moving image, it is difficult for the driver to attend to a handover request of the system immediately. In view of this, the output control unit 20 performs a control in, for example, a manner shown in FIG. 4 as part of the handover advance notice control (step S15 shown in FIG. 3).

The example shown in FIG. 4 shows how the form of display on the screen of the display of an IVI device varies as a transition is made from an IVI display 31A (initial state) to an IVI display 31B then to an IVI display 31C. More specifically, a control is made so that the brightness of the display on the screen lowers gradually by adjusting the brightness of illumination by the backlight.

An actual control may be such as to darken the display gradually as shown in FIG. 4 in about one to several minutes, for example. The brightness may be adjusted stepwise every prescribed time so that the driver can recognize a brightness variation more easily. Alternatively, the brightness may be varied continuously, in which case the driver would realize a brightness change after a lapse of a certain period.

In either case, where the driver is doing an act that is irrelevant to driving using the display of an IVI device, he or she would realize, gradually, the slow variation as shown in FIG. 4. The driver can continue the act for a while even if the display becomes a little difficult to watch, because the variation is slow. However, since the display becomes difficult to watch little by little, the degree of concentration of the driver on the watching of the display would lower gradually. The driver is forced to stop the watching act naturally after a lapse of a certain period and hence would get ready for a handover. With this measure, the driver may switch to the manual drive mode voluntarily before the self vehicle reaches the scheduled handover point P0.

Although in the example of FIG. 4 the brightness of the display is adjusted, the display form may be adjusted by another method. For example, the window size of an application being manipulated by the driver may be adjusted gradually so as to decrease gradually.

Instead of using the IVI device, a display on the screen of an audio device or a navigation device irrelevant to driving may be controlled in the same manner as shown in FIG. 4. However, where a picture relating to driving such as a road map is being displayed, it may be excluded from the target of control depending on the situation.

### <Example of Variation of Display of Front Scene>

FIG. 5 shows an example of how a display of a front scene is varied when the characteristic information presentation control is performed. In the example shown in FIG. 5, visual information representing a running lane of the self vehicle and visual information representing a scheduled handover point P0 are superimposed on a scene that is seen through the windshield as a front scene display 32A, 32B, or 32C utilizing the display function of an HUD device.

In the example of FIG. 5, a transition is made from the front scene display 32A (initial state) to the front scene display 32B then to the front scene display 32C as the self vehicle runs forward. The front scene displays 32A, 32B, and 32C are stereoscopic displays with perspective; that is, a situation that the self vehicle is approaching a scheduled handover point P0 gradually is expressed as variations of the display size and position of a visual image representing the scheduled handover point P0.

Seeing the transitions between the superimposed front scene displays 32A, 32B, and 32C, the driver can recognize an approach to the scheduled handover point P0 and can get ready for a handover gradually.

### <Sound Volume Adjustment>

Although not shown in any drawings, where the driver is listening to music or a sound of, for example, a TV program during an autonomous drive, the output control unit 20 adjusts, automatically, at step S15 shown in FIG. 3, the sound volume of a car audio device that is emitting the music or sound. That is, the output control unit 20 decreases the volume of the music or sound from the initial state in a certain period.

As a result, the driver recognizes that the music or sound is becoming hard to hear little by little and the degree of concentration on the listening to it would lower. The driver would get ready for a handover little by little.

### <Causing Driver to Think of End>

Although not shown in any drawings, where the driver is doing some act irrelevant to driving during an autonomous drive, it is possible to cause the driver to think of the end of something by reproducing and outputting such a musical piece as “Auld Lang Syne.” The output control unit 20 reproduces and outputs the musical piece “Auld Lang Syne” additionally and performs a control so that its volume increases gradually from the initial state at step S15 shown in FIG. 3.

As a result, as the self vehicle comes closer to the scheduled handover point P0, the driver would gradually think of a situation that he or she stops the act and prepares for a handover and hence can get ready for the handover gradually.

### <Advantages of Method for Conveying Information During an Autonomous Drive and Vehicular Information Presenting Device>

Where the method for conveying information during an autonomous drive having the process shown in FIG. 3 is employed, when the self vehicle has come a position that is close to a scheduled handover point P0 to a certain extent, it is possible to notify, gradually, the driver of the approach to the scheduled handover point P0 by an expression form that is relatively low in intensity. As a result, the driver can get ready for a handover keeping his or her composure.

The driver can recognize a scheduled handover at an early stage. Furthermore, since a display on the screen, for example, varies slowly, the driver can decide, by himself or herself, by his or her own volition, when to stop an act or the like he or she has been doing. It is therefore possible to cause the driver to get ready for a handover without lowering the comfortability of an autonomous drive.

### <Outline of Modification>

In the information presentation control shown in FIG. 3, a handover advance notice control is performed at step S15 and the quantity of stimulus generated by this control is adjusted automatically so as to vary gradually and continuously or stepwise in such a manner that the driver can recognize the variation.

However, where the quantity of stimulus is varied continuously (smoothly), the driver may have difficulty recognizing the variation or, conversely, the driver may feel the continuous variation to be annoying. On the other hand, where the quantity of stimulus is varied stepwise, each change may be too small to be recognized by the driver or so large as to cause him or her feel uncomfortable. Further, the driver may have difficulty recognizing a variation of the quantity of stimulus being influenced by a variation of ambient brightness or environmental noise. It is therefore difficult to determine a proper stimulus quantity.

For example, among the fundamental laws of psychophysics that relate to the human senses (five senses) are Weber's law and Fechner's law.

Weber's law is that the relationship between the stimulus quantity X and the minimum stimulus variation ΔX that a human can perceive is given by the following Equation (1):

ΔX/X=C (1)

where C is a constant.

Fechner's law is that the perceived intensity Y is proportional to the logarithm of the stimulus quantity X, as is given by the following Equation (2):

Y=k·Log(X)+C (2)

where k and C are constants.

That is, when a human is receiving a strong stimulus, he or she does not realize its variation unless it is large. On the other hand, when a human is receiving a weak stimulus, he or she realizes its variation even if it is small.

In this modification, in view of the above, in the information presentation control shown in FIG. 3, the stimulus quantity is varied stepwise and the variation amount is varied properly according to the human sensory properties.

### <Example Configuration of Vehicular System According to Modification>

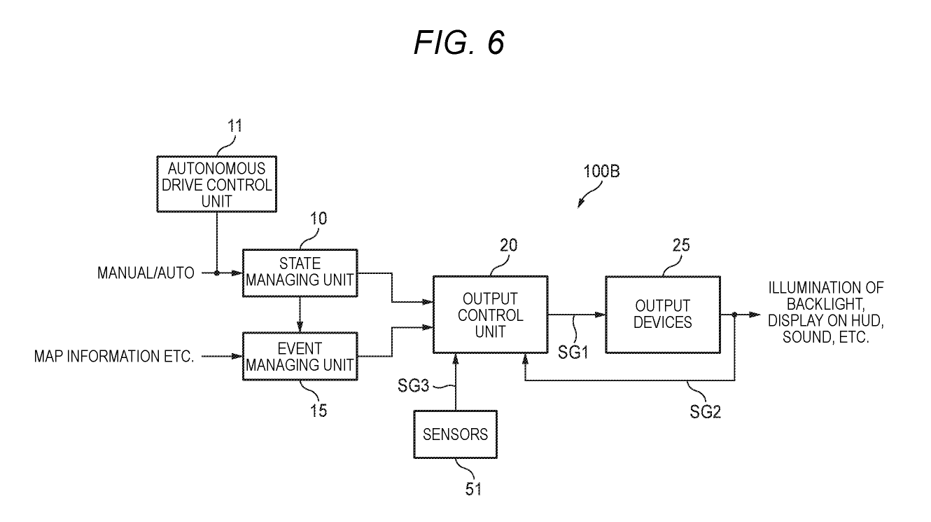

FIG. 6 shows an example configuration of a vehicular system according to the modification. A vehicular information presentation control device 100B shown in FIG. 6 is equipped with sensors 51 for detecting, for example, ambient brightness in the vehicle compartment and a sound volume of environmental noise. An environment detection signal SG3 that is output from the sensors 51 is input to an output control unit 20. Part of an output signal of the output devices 25 is input to the output control unit 20 as a feedback signal SG2.

The output control unit 20 shown in FIG. 6 generates an information presentation control signal SG1 so that it reflects the feedback signal SG2 and the environment detection signal SG3. A specific operation that the output control unit 20 performs to cause the information presentation control signal SG1 to reflect the feedback signal SG2 and the environment detection signal SG3 will be described later in detail. The other part of the configuration and the other operations of the vehicular information presentation control device 100B are the same as those of the vehicular information presentation control device 100 shown in FIG. 2.

### <Examples of Time-Series Variation of Stimulus Quantity>

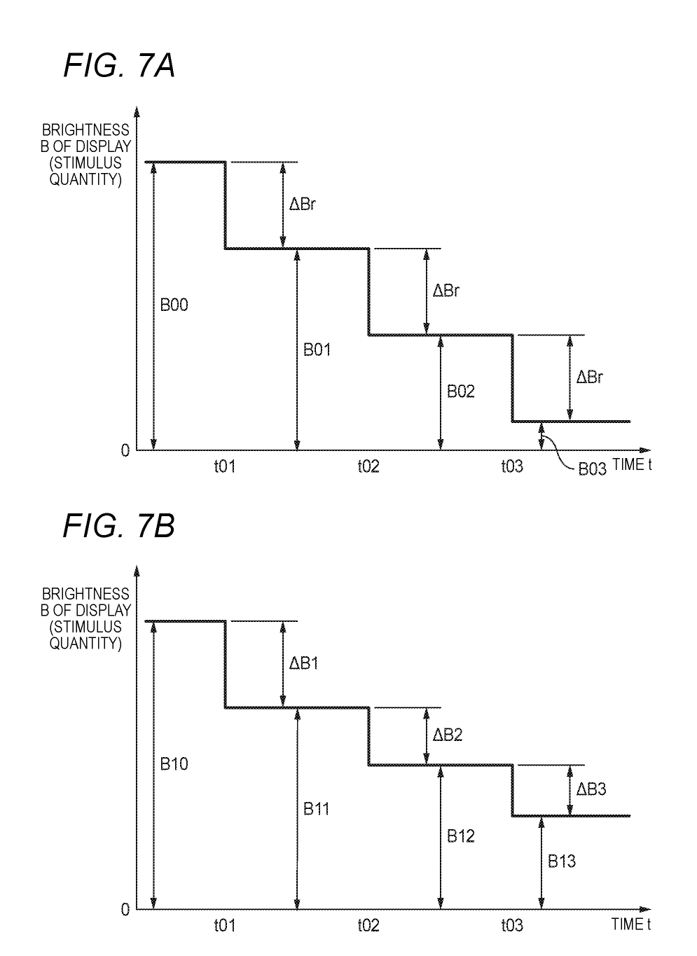

FIGS. 7A and 7B shows examples of a time-series variation of the stimulus quantity in a case that the stimulus quantity is varied stepwise. In FIGS. 7A and 7B, the horizontal axis represents time t and the vertical axis represents the brightness B of a display on the screen that corresponds to the stimulus quantity.

To obtain the time-series variation shown in FIG. 7A, a control is made so that the brightness B is varied stepwise so as to be changed by a constant stimulus variation ΔBr every time a fixed time elapses.

More specifically, in the example of FIG. 7A, the brightness B is changed from a stimulus quantity BOO to a stimulus quantity B01 at time t01, from the stimulus quantity B01 to a stimulus quantity B02 at time t02, and from the stimulus quantity B02 to a stimulus quantity B03 at time t03. The difference between the stimulus quantities BOO and B01, the difference between the stimulus quantities B01 and B02, the difference between the stimulus quantities B02 and B03 are equal to the fixed stimulus variation ΔBr.

Where the brightness B is varied stepwise as shown in FIG. 7A, if the stimulus variation ΔBr is relatively small, the variation at time t01 may be so small that the driver has difficulty realizing it. On the other hand, if the stimulus variation ΔBr is relatively large, it is highly probable that the variation at time t03 is so large that the driver feels uncomfortable.

In view of the above, the output control unit 20 employed in the modification shown in FIG. 6 controls the stimulus variation in, for example, a manner shown in FIG. 7B. More specifically, in the example of FIG. 7B, the brightness B is changed from a stimulus quantity B10 to a stimulus quantity B11 at time t01, from the stimulus quantity B11 to a stimulus quantity B12 at time t02, and from the stimulus quantity B12 to a stimulus quantity B13 at time t03.

The difference between the stimulus quantities B10 and B11 is equal to a stimulus variation ΔB1, the difference between the stimulus quantities B11 and B12 is equal to a stimulus variation ΔB2, and the difference between the stimulus quantities B12 and B13 is equal to a stimulus variation ΔB3. The stimulus variation ΔB1 is determined so as to reflect the stimulus quantity B10 before the change, the stimulus variation ΔB2 is determined so as to reflect the stimulus quantity B11 before the change, and the stimulus variation ΔB3 is determined so as to reflect the stimulus quantity B12 before the change.

Where the stimulus variations ΔB1, ΔB2, and ΔB3 shown in FIG. 7B are employed, proper stimulus variations that are at such levels as to cause the driver to realize the changes can be produced according to Equations (1) and (2) at time t01, time t02 and time t03 of the switching. Although the example of FIG. 7B assumes the case that the brightness B of a display on the screen is controlled as the stimulus quantity, a similar control can be made even in a case that any of the other ones of the human five senses is stimulated.

### <Example of Handover Advance Notice Control in Modification>

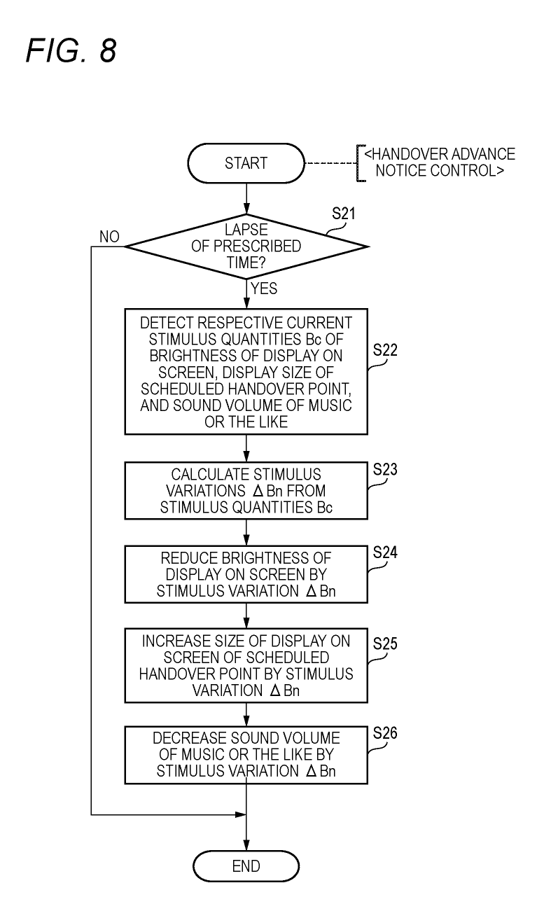

FIG. 8 shows an example handover advance notice control according to the modification of the embodiment. The control shown in FIG. 8 is performed in a case that the output control unit 20 shown in FIG. 6 performs a handover advance notice control at step S15 shown in FIG. 3. The brightness B can be adjusted so as to have, for example, the stimulus variations ΔB1, ΔB2, and ΔB3 shown in FIG. 7B. The process shown in FIG. 8 will be described below.

Every time a prescribed time elapses (step S21), the output control unit 20 executes steps S21 to S22. At step S22, the output control unit 20 detects current stimulus quantities Bc. More specifically, the output control unit 20 receives, as a feedback signal SG2 that is output from the output devices 25, respective current stimulus quantities Bc of, for example, the brightness of a display on the screen of, for example, a moving image content being reproduced, the display size on the screen of a scheduled handover point to be displayed, and the sound volume of music or the like being reproduced. Furthermore, to recognize the magnitude of a current environmental stimulus, the output control unit 20 receives an environment detection signal SG3 from the sensors 51.

At step S23, the output control unit 20 calculates stimulus variations ΔBn on the basis of the current stimulus quantities Bc detected at step S22. Naturally, stimulus variations ΔBn are calculated individually for, for example, the brightness of a display on the screen, the display size of a scheduled handover point, and the sound volume of music or the like.

Since the driver receives stimuli other than outputs of the output devices 25, such as ambient illumination and environmental noise, the output control unit 20 automatically switches the calculation formulae used in calculating stimulus variations ΔBn at step S23 according to the environment detection signal SG3.

At step S24, the output control unit 20 changes the brightness of a display on the screen of a moving image content being reproduced so as to reduce it by the stimulus variation ΔBn calculated at step S23. For example, at time t01 shown in FIG. 7B, the output control unit 20 decreases the brightness of a display on the screen stepwise by the stimulus variation ΔB1 from a value B10 to B11.

Likewise, at step S25, the output control unit 20 changes the display size of a scheduled handover point on the screen so as to increase it by the stimulus variation ΔBn calculated at step S23. At step S26, the output control unit 20 changes the sound volume of music or the like being reproduced so as to decrease it by the stimulus variation ΔBn calculated at step S23.

In the handover advance notice control shown in FIG. 8, the brightness of a display on the screen, for example, is adjusted automatically so that the driver can recognize visually and enjoy a video of a moving image content or the like even in a final state that the stimulus has been minimized before the end of this control.

### <Relationship Between Stimulus Quantity and Stimulus Variation>

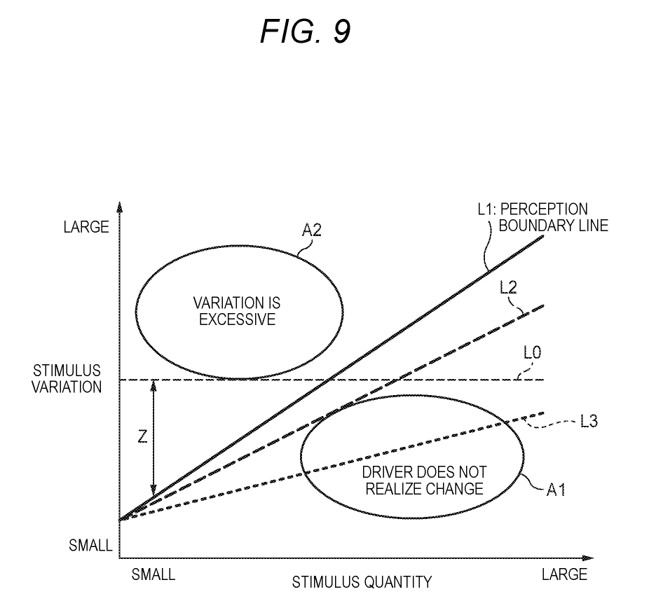

FIG. 9 shows a relationship between the stimulus quantity and the stimulus variation. As shown in FIG. 9, a perception boundary line L1 that indicates, according to the above-mentioned Equation (1), a boundary between an area where the driver can perceive an output stimulus and an area where the driver cannot is one relationship between the stimulus quantity and the stimulus variation. In an actual environment in the vehicle, since the total stimulus varies being influenced by the ambient brightness or the environmental noise, the perception boundary line L1 for the driver varies according to the external environment to, for example, a perception boundary line L2 or L3.

A characteristic L0 shown in FIG. 9 of a case that the stimulus variation is constant corresponds to the case as shown in FIG. 7A in which the stimulus quantity is controlled so as to be changed stepwise by a fixed stimulus variation ΔBr at each time. In the case of this control, when the stimulus quantity is large, the characteristic L0 is located below the perception boundary line L1 and hence is in or around an area A1 where the driver does not recognize the change. On the other hand, when the stimulus quantity is small, the characteristic L0 is located above the perception boundary line L1 and hence is in or around an area A2 where the variation is excessive.

That is, the stimulus variation is insufficient or excessive by a difference Z from the perception boundary line L1. When the stimulus variation is insufficient, the driver could not recognize a stimulus change. When the stimulus variation is excessive, the driver would feel uncomfortable by a degree corresponding to the difference Z from the perception boundary line L1.

Since the output control unit 20 performs the handover advance notice control shown in FIGS. 7B and 8, the stimulus variation ΔBn can be adjusted automatically according to the characteristic of the perception boundary line L1 shown in FIG. 9. Where the stimulus to the driver is influenced by the external environment, the stimulus variation ΔBn can be adjusted automatically according to, for example, the characteristic of a perception boundary line L2 or L3 shown in FIG. 9.

### <Realistic Example of Time-Series Variation of Stimulus Quantity>

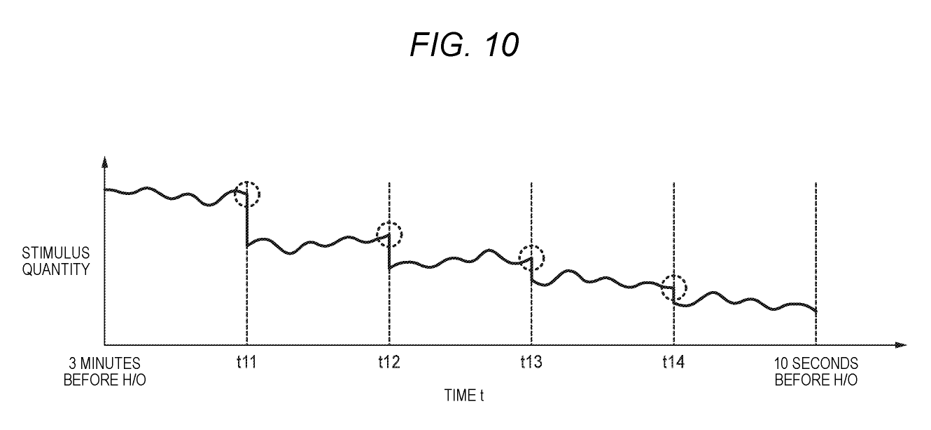

FIG. 10 shows a realistic example of a time-series variation of the stimulus quantity. The example of FIG. 10 shows how the stimulus quantity (e.g., brightness or sound volume) varies from 3 minutes before a handover to 10 seconds before it.

When the output control unit 20 shown in FIG. 6 performs a handover advance notice control as shown in FIGS. 7B and 8, the actual stimulus quantity makes a time-series variation in, for example, a manner shown in FIG. 10. More specifically, as shown in FIG. 10, the stimulus quantity is changed stepwise by proper stimulus variations ΔBn at time t11, t12, t13, and t14, respectively. However, a brightness or sound volume variation of a content itself being reproduced and a brightness or sound volume variation due to an external environment are added, the stimulus quantity varies a little at time points other than time t11, t12, t13, and t14. In any case, the driver can realize a stimulus change at each of time t11, t12, t13, and t14.

### <Other Probable Modifications>

Whereas the above embodiment is directed to the case that the stimulus to the driver is controlled for the purpose of advance notification of a handover, such a stimulus control can also be used for other purposes. That is, in a case that a certain target point other than a scheduled handover point is determined, information can be conveyed to the driver by calculating proper stimulus variations ΔB1, ΔB2, ΔB3, . . . and changing the stimulus quantity stepwise by these values in the same manner as shown in FIG. 7B at time points before a time point when to reach the target point or at locations short of the target point.

Whereas the above embodiment is directed to the case that the output devices 25 that generate a visual stimulus and an auditory stimulus, another type or other types of output device(s) may be used that stimulate one or plural ones of the others of the human five senses. For example, it is possible to employ a device that generates a scent and/or a device that stimulates the tactile sense.

Features of the above-described method for conveying information during an autonomous drive and vehicular information presenting device according to the embodiment of the invention will be summarized below concisely in the form of items [1] to [12]:

[1] A method for conveying information during an autonomous drive which presents information to a driver in a vehicle having, as running states, two or more states that are different from each other in the degree of involvement of the driver in drive control, wherein:
the running states include a first state in which the drive control is performed automatically and a second state that is higher in the degree of involvement of the driver in drive control than the first state; and
if an encounter with an event that may cause switching from the first state to the second state is predicted,
   explicit information is conveyed to the driver at a point (scheduled switching notice issuance point P1) in the vicinity of a scheduled switching point (scheduled handover point P0) where switching from the first state to the second state will occur because of an encounter with the event (S17), and
   the information is conveyed to the driver using an output device or devices (25) that stimulate at least one of the five senses of the driver in such a manner that the stimulus quantity is varied stepwise or continuously from an initial quantity between a switching advance notice start point (P2) that is more distant from the scheduled switching point than the point in the vicinity of it is and the scheduled switching point (S15).

[2] The method for conveying information during an autonomous drive according to item [1], wherein a display on a screen that is irrelevant to driving (display 31A, 31B, 31C on the IVI screen) is caused to make a transition to a state that is hard to recognize visually, gradually and stepwise or continuously between the switching advance notice start point and the scheduled switching point (S15; see FIG. 4).

[3] The method for conveying information during an autonomous drive according to item [1], wherein the display size of visible information that relates to the event is increased gradually and stepwise or continuously between the switching advance notice start point and the scheduled switching point (S15; see FIG. 5).

[4] The method for conveying information during an autonomous drive according to item [1], wherein the sound volume of a content that is irrelevant to driving is decreased gradually and stepwise or continuously between the switching advance notice start point and the scheduled switching point (S15).

[5] The method for conveying information during an autonomous drive according to item [1], wherein a musical piece that would cause the driver to think of an end of an autonomous drive is output additionally and the sound volume of the musical piece is increased gradually and stepwise or continuously between the switching advance notice start point and the scheduled switching point (S15).

[6] The method for conveying information during an autonomous drive according to item [1], wherein:
the first state is a state in which the running speed and direction of the vehicle are controlled automatically and no assistance of the driver to the drive control is necessary; and
the second state is a state in which the running speed and direction of the vehicle are controlled automatically but assistance of the driver to the drive control is required.

[7] The method for conveying information during an autonomous drive according to item [1], wherein:
the first state is a state in which the running speed and direction of the vehicle are controlled automatically; and
the second state is a state in which at least one of the running speed and the running direction of the vehicle is controlled by the driver.

[8] A vehicular information presenting device (vehicular information presentation control device 100) for presenting information to a driver in a vehicle having, as running states, two or more states that are different from each other in the degree of involvement of the driver in drive control, wherein:
the running states include a first state in which the drive control is performed automatically and a second state that is higher in the degree of involvement of the driver in driving control than the first state;
the vehicular information presenting device comprises an information output control unit (output control unit 20) which outputs, in association with switching from the first state to the second state, information relating to the switching; and
that if an encounter with a special event that may cause switching from the first state to the second state is predicted, the information output control unit
   conveys explicit information to the driver at a point (scheduled switching notice issuance point P1) in the vicinity of a scheduled switching point (scheduled handover point P0) where switching from the first state to the second state will occur because of an encounter with the event; and
   conveys the information to the driver using an output device or devices (25) that stimulate at least one of the five senses of the driver in such a manner that the stimulus quantity is varied stepwise or continuously from an initial quantity between a switching advance notice start point (P2) that is more distant from the scheduled switching point than the point in the vicinity of it is and the scheduled switching point.

[9] The vehicular information presenting device according to item [8], wherein:
the first state is a state in which the running speed and direction of the vehicle are controlled automatically and no assistance of the driver to the drive control is necessary; and
the second state is a state in which the running speed and direction of the vehicle are controlled automatically but assistance of the driver to the drive control is required.

[10] The vehicular information presenting device according to item [8], wherein:
the first state is a state in which the running speed and direction of the vehicle are controlled automatically; and
the second state is a state in which at least one of the running speed and the running direction of the vehicle is controlled by the driver.

[11] The method for conveying information during an autonomous drive according to items [1] to [5], wherein:
the information is conveyed to the driver using the output device or devices by a stimulus control of varying the stimulus quantity stepwise between the switching advance notice start point and the scheduled switching point; and
in the stimulus control the variation amount (ΔBn) of each change of the stimulus quantity is variable reflecting a stimulus quantity (feedback signal SG2, stimulus quantity Bc) before the change (S23).

[12] The method for conveying information during an autonomous drive according to item [11], wherein:
in the stimulus control an environmental stimulus quantity (environment detection signal SG3) other than an output or outputs of the output device or devices is detected; and
the variation amount is determined automatically so as to reflect the detected environmental stimulus quantity (S23).

What is claimed is:

1. A method for conveying information during an autonomous drive which presents information to a driver in a vehicle having, as running states, two or more states that are different from each other in the degree of involvement of the driver in drive control, wherein:
the running states include a first state in which the drive control is performed automatically and a second state that is higher in the degree of involvement of the driver in drive control than the first state; and
if an encounter with an event that may cause switching from the first state to the second state is predicted,
explicit information is conveyed to the driver at a point in the vicinity of a scheduled switching point where switching from the first state to the second state will occur because of an encounter with the event; and
the information is conveyed to the driver using an output device or devices that stimulate at least one of the five senses of the driver in such a manner that the stimulus quantity is varied stepwise or continuously from an initial quantity between a switching advance notice start point that is more distant from the scheduled switching point than the point in the vicinity of it is and the scheduled switching point.

2. The method for conveying information during an autonomous drive according to claim 1, wherein a display on a screen that is irrelevant to driving is caused to make a transition to a state that is hard to recognize visually, gradually and stepwise or continuously between the switching advance notice start point and the scheduled switching point.

3. The method for conveying information during an autonomous drive according to claim 1, wherein the display size of visible information that relates to the event is increased gradually and stepwise or continuously between the switching advance notice start point and the scheduled switching point.

4. The method for conveying information during an autonomous drive according to claim 1, wherein the sound volume of a content that is irrelevant to driving is decreased gradually and stepwise or continuously between the switching advance notice start point and the scheduled switching point.

5. The method for conveying information during an autonomous drive according to claim 1, wherein a musical piece that would cause the driver to think of an end of an autonomous drive is output additionally and the sound volume of the musical piece is increased gradually and stepwise or continuously between the switching advance notice start point and the scheduled switching point.

6. A vehicular information presenting device for presenting information to a driver in a vehicle having, as running states, two or more states that are different from each other in the degree of involvement of the driver in drive control, wherein:
the running states include a first state in which the drive control is performed automatically and a second state that is higher in the degree of involvement of the driver in drive control than the first state;
the vehicular information presenting device comprises an information output control unit which outputs, in association with switching from the first state to the second state, information relating to the switching; and
if an encounter with a special event that may cause switching from the first state to the second state is predicted, the information output control unit
conveys explicit information to the driver at a point in the vicinity of a scheduled switching point where switching from the first state to the second state will occur because of an encounter with the event; and
conveys the information to the driver using an output device or devices that stimulate at least one of the five senses of the driver in such a manner that the stimulus quantity is varied stepwise or continuously from an initial quantity between a switching advance notice start point that is more distant from the scheduled switching point than the point in the vicinity of it is and the scheduled switching point.

7. The method for conveying information during an autonomous drive according to claim 1, wherein:
the information is conveyed to the driver using the output device or devices by a stimulus control of varying the stimulus quantity stepwise between the switching advance notice start point and the scheduled switching point; and
in the stimulus control the variation amount of each change of the stimulus quantity is variable reflecting a stimulus quantity before the change.

8. The method for conveying information during an autonomous drive according to claim 7, wherein:
in the stimulus control an environmental stimulus quantity other than an output or outputs of the output device or devices is detected; and
the variation amount is determined automatically so as to reflect the detected environmental stimulus quantity.
